(19) United States
(12) Patent Application Publication
(10) Pub. No.: US 2026/0169846 A1
(43) Pub. Date: Jun. 18, 2026

(54) Smart Mechanism for Synchronizing Multiple Job Types in a Concurrent Scale-out Environment

(71) Applicant: ServiceNow, Inc., Santa Clara, CA (US)

(72) Inventors: Vadim Dukhovny, Petah Tikva (IL); Dov Miron, Petach Tikva (IL); Regina Ring, Petach Tikva (IL)

(21) Appl. No.: 18/983,741

(22) Filed: Dec. 17, 2024

(51) Int. Cl. G06F 11/07

(52) U.S. Cl. CPC G06F 11/0781; G06F 11/0709; G06F 11/079

(57) ABSTRACT

A method includes obtaining a plurality of alerts. Each alert is associated with a respective cause for the alert. The method includes assigning each alert to a respective bucket of a plurality of buckets based on separation criteria. The method also includes distributing the alerts across a plurality of grouping jobs based on the assigned respective bucket. Each grouping job is associated with one or more buckets of the plurality of buckets. For each grouping job, the method includes grouping the alerts within each bucket based on the respective cause for each alert. After each grouping job groups the alerts within each bucket, the method includes generating, for each group of alerts, a single notification.

### TECHNICAL FIELD

This disclosure relates to synchronizing job types in a concurrent scale-out environment.

### BACKGROUND

In conventional cloud infrastructure monitoring systems, alerts are generated to notify administrators of various issues affecting data center components such as servers, firewalls, load balancers, routers, and switches. These alerts can be triggered by a wide range of problems, including hardware malfunctions, software errors, and network disruptions. Typically, these systems generate a high volume of alerts, which can quickly overwhelm administrators and make it difficult to identify and address the root causes of issues efficiently.

### SUMMARY

One aspect of the disclosure provides a method for grouping alerts in a scale-out environment. The computer-implemented method includes obtaining a plurality of alerts. Each alert of the plurality of alerts is associated with a respective cause for the alert. The method includes assigning each alert to a respective bucket of a plurality of buckets based on separation criteria. The method includes distributing the alerts across a plurality of grouping jobs based on the assigned respective bucket. Each grouping job is associated with one or more buckets of the plurality of buckets. For each grouping job, the method includes grouping the alerts within each bucket based on the respective cause for each alert. After each grouping job groups the alerts within each bucket, the method includes generating, for each group of alerts, a single notification.

Implementations of the disclosure may include one or more of the following optional features. In some implementations, the separation criteria are based on one or more attributes of the alerts. In some of these implementations, the one or more attributes include at least one of a source of the alert, a type of the alert, a severity of the alert, or a time the alert was generated.

Optionally, grouping the alerts within each bucket based on the respective cause for each alert includes identifying alerts with the same root cause. Identifying alerts with the same root cause may include determining at least one of a text similarity, a tag similarity, or a correlation analysis for each alert. In some examples, generating the single notification includes generating an incident report.

The method may further include, after each grouping job groups the alerts within each bucket, performing, for each group of alerts, remediation. In some implementations, the method further includes determining a current alert volume and, based on the determined current alert volume, scaling a number of the plurality of grouping jobs. Each grouping job may be executed in parallel with each other grouping job.

In some examples, the method further includes, prior to generating the single notification, determining that each grouping job has completed grouping the alerts within each bucket. In some of these examples, determining that each grouping job has completed includes waiting for a threshold amount of time. The threshold amount of time may be based on a user preference.

In some implementations, the method further includes, for each grouping job, generating a respective hash marker indicating a completion status of the grouping job in a synchronization table and determining, based on the synchronization table, that all the grouping jobs have completed. Optionally, the method further includes, for each grouping job, generating a respective hash marker indicating a completion status of the grouping job in a synchronization table and determining, based on the synchronization table, a grouping job has failed to complete. In some of these examples, the method further includes reassigning the alerts assigned to the grouping job that failed to complete to a different grouping job and updating the synchronization table based on the reassignment.

In some examples, each alert of the plurality of alerts is based on a status of a data center. In some of these examples, each alert of the plurality of alerts is associated with at least one of a server, a firewall, a load balancer, a router, or a switch.

Another aspect of the disclosure provides a system for grouping alerts in a scale-out environment. The system includes data processing hardware and memory hardware in communication with the data processing hardware. The memory hardware stores instructions that when executed on the data processing hardware cause the data processing hardware to perform operations. The operations include obtaining a plurality of alerts. Each alert of the plurality of alerts is associated with a respective cause for the alert. The operations include assigning each alert to a respective bucket of a plurality of buckets based on separation criteria. The operations include distributing the alerts across a plurality of grouping jobs based on the assigned respective bucket. Each grouping job is associated with one or more buckets of the plurality of buckets. For each grouping job, the operations include grouping the alerts within each bucket based on the respective cause for each alert. After each grouping job groups the alerts within each bucket, the operations include generating, for each group of alerts, a single notification.

This aspect may include one or more of the following optional features. In some implementations, the separation criteria are based on one or more attributes of the alerts. In some of these implementations, the one or more attributes include at least one of a source of the alert, a type of the alert, a severity of the alert, or a time the alert was generated.

Optionally, grouping the alerts within each bucket based on the respective cause for each alert includes identifying alerts with the same root cause. Identifying alerts with the same root cause may include determining at least one of a text similarity, a tag similarity, or a correlation analysis for each alert. In some examples, generating the single notification includes generating an incident report.

The operations may further include, after each grouping job groups the alerts within each bucket, performing, for each group of alerts, remediation. In some implementations, the operations further include determining a current alert volume and, based on the determined current alert volume, scaling a number of the plurality of grouping jobs. Each grouping job may be executed in parallel with each other grouping job.

In some examples, the operations further include, prior to generating the single notification, determining that each grouping job has completed grouping the alerts within each bucket. In some of these examples, determining that each grouping job has completed includes waiting for a threshold amount of time. The threshold amount of time may be based on a user preference.

In some implementations, the operations further include, for each grouping job, generating a respective hash marker indicating a completion status of the grouping job in a synchronization table and determining, based on the synchronization table, that all the grouping jobs have completed. Optionally, the operations further include, for each grouping job, generating a respective hash marker indicating a completion status of the grouping job in a synchronization table and determining, based on the synchronization table, a grouping job has failed to complete. In some of these examples, the operations further include reassigning the alerts assigned to the grouping job that failed to complete to a different grouping job and updating the synchronization table based on the reassignment.

In some examples, each alert of the plurality of alerts is based on a status of a data center. In some of these examples, each alert of the plurality of alerts is associated with at least one of a server, a firewall, a load balancer, a router, or a switch.

Another embodiment of the disclosure provides a computer-readable medium having instructions that, when executed by data processing hardware, causes the data processing hardware to perform operations. The operations include obtaining a plurality of alerts. Each alert of the plurality of alerts is associated with a respective cause for the alert. The operations include assigning each alert to a respective bucket of a plurality of buckets based on separation criteria. The operations include distributing the alerts across a plurality of grouping jobs based on the assigned respective bucket. Each grouping job is associated with one or more buckets of the plurality of buckets. For each grouping job, the operations include grouping the alerts within each bucket based on the respective cause for each alert. After each grouping job groups the alerts within each bucket, the operations include generating, for each group of alerts, a single notification.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for grouping alerts in a scale-out environment.

FIG. 2 is a schematic view of an example bucket assignor.

FIG. 3 is a schematic view of an example grouping controller and notification generator.

FIG. 4 is a flowchart of an example arrangement of operations for a method of grouping alerts.

FIG. 5 is a schematic view of an example computing device that may be used to implement the systems and methods described herein.

Like reference symbols in the various drawings indicate like elements.

### DETAILED DESCRIPTION

The conventional approach to alert management in cloud infrastructure monitoring systems faces significant challenges, particularly in terms of scalability and resiliency. For example, to manage an influx of alerts, existing systems may employ a grouping mechanism that consolidates similar alerts to reduce clutter and improve manageability. This grouping is generally performed by a single job that processes incoming alerts and groups them based on predefined criteria. However, as the volume of alerts increases, this single-job approach can become a bottleneck, leading to delays in alert processing and potentially causing critical issues to go unnoticed or unresolved in a timely manner.

To address these challenges, implementations herein are directed toward a scalable and resilient alert management system that provides grouping and processing of alerts. The system allows multiple grouping jobs to run in parallel, dynamically scaling based on the volume of incoming alerts. By distributing the alert processing workload across multiple jobs, the system enhances performance and reduces the time required to group and manage alerts. Additionally, the system's resiliency is improved, as the system can continue processing alerts even if one or more jobs fail, thereby eliminating the single point of failure inherent in conventional systems.

These implementations may include a scalable alert grouping mechanism that allows multiple grouping jobs to run in parallel. This parallel execution significantly enhances the system's performance by distributing the alert processing workload across multiple jobs. Each job handles a specific set of alerts, ensuring no overlap and efficient processing. The system can dynamically scale the number of grouping jobs based on the current alert volume, allowing the system to handle high volumes of alerts without becoming a bottleneck. This dynamic scaling can be configured to occur in real-time as alerts are received, ensuring that the system remains responsive and efficient under varying load conditions.

Advantageously, these implementations may include an alert grouping mechanism that assigns alerts to specific buckets based on separation criteria. Each bucket is then processed by a dedicated grouping job, ensuring efficient distribution and parallel processing of alerts. This approach not only accelerates alert processing but also ensures that alerts with the same root cause are grouped together, reducing the number of notifications presented to administrators and enabling quicker identification and resolution of issues.

Moreover, the system may incorporate a synchronization algorithm that coordinates the timing of alert management jobs. This algorithm ensures that incident reports and notifications are generated only after all grouping jobs have completed, preventing the creation of multiple incidents for the same issue and maintaining a streamlined alert management process. The configurable delay mechanism balances the need for timely incident creation with the goal of avoiding unnecessary clutter.

The system may employ a sophisticated bucket determination mechanism to assign alerts to specific buckets based on separation criteria. This determination can be performed in two phases. In the first phase, the bucket calculation is done in memory by each job, ensuring quick and efficient assignment of alerts to buckets. In the second phase, a dedicated job performs the bucket calculation and stores the results in a new column in an alert table. This approach may ensure that alerts are efficiently distributed across grouping jobs, reducing the likelihood of processing delays and improving overall system performance.

Optionally, the system integrates tag-based grouping into the query job, which operates transparently with the scale-out feature. This means that alerts can be grouped based on tags, which are labels or categories assigned to alerts based on their attributes. Tag-based grouping allows for more granular and meaningful grouping of alerts, making it easier for administrators to identify and address specific issues. This feature enhances the flexibility and effectiveness of the alert grouping mechanism, allowing it to adapt to different types of alerts and user preferences.

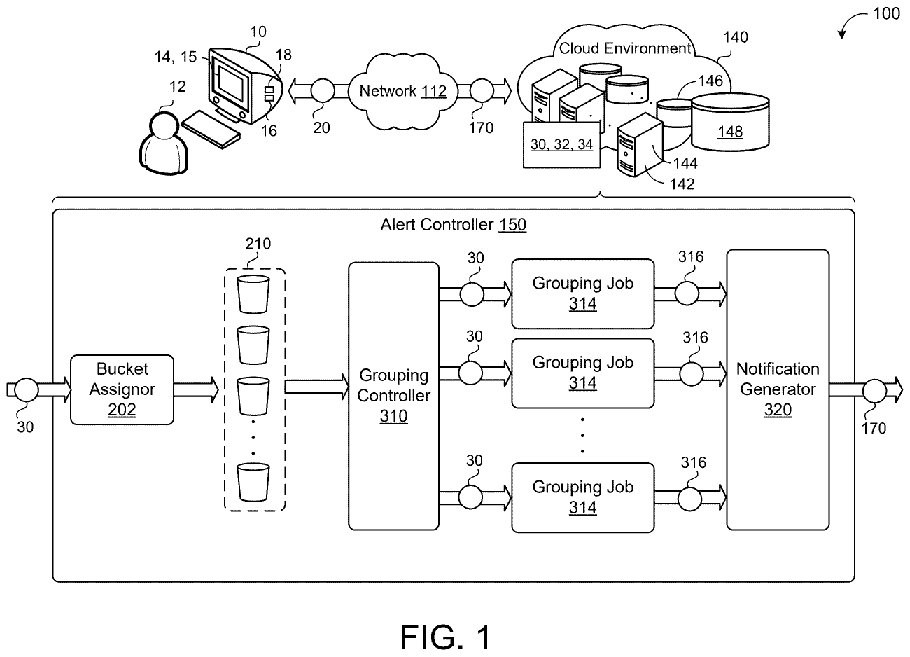

FIG. 1 is a schematic view of an example system 100 for grouping alerts in a scalable manner. The system 100 includes a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 15 for display on a screen 14 in communication with the data processing hardware 18. The GUI 15 may be provided by a web browser, a web application, a native application, or a hybrid application running on the user device 10. The GUI 15 may allow the user 12 to view, manage, or configure alerts, notifications, or other information related to the system 100.

The remote system 140 executes an alert controller 150 that the user device 10 communicates with via, for example, the network 112. The alert controller 150 is a software application or module that is configured to group alerts 30 in a scalable manner based on their causes and generate notifications 170 for each group 316 of alerts 30, as described in more detail below. The alert controller 150 may interact with other software applications or modules that provide the GUI 15 or the alerts, such as a web server, a web application, a native application, or a hybrid application. Some or all the alert controller 150, in some examples, executes on the user device 10 in lieu of or in addition to the remote system 140.

The alert controller 150 obtains or receives a plurality of alerts 30. The alerts 30 may be generated by the remote system 140 (e.g., by one or more hardware and/or software modules of the remote system 140). Additionally or alternatively, the remote system 140 receives the alerts 30 from an external source, such as from the user device 10 or a third-party application. Each alert 30 may be associated with an alert source 32 that generates the corresponding alert 30. In some examples, the alert source 32 is any component, device, or system that generates or sends alerts 30 based on the status or performance of a data-intensive environment, such as a data center, a cloud computing platform, or a network monitoring system. For example, the alert source 32 includes one or more servers, firewalls, load balancers, routers, switches, or other components that monitor or control the data-intensive environment.

The alert source 32 may generate alerts 30 based on various criteria, such as thresholds, rules, policies, events, or anomalies, that indicate the occurrence or potential occurrence of an issue, such as a failure, an error, a bottleneck, or a deviation, that may affect the operation or availability of the data-intensive environment. Due to the scalable and distributed nature of the remote system 140, the quantity of alerts 30 obtained or received by the alert controller 150 may be very high (e.g., thousands or more) such that a user 12 cannot reasonably review each alert 30 individually. For example, in a large data center with numerous servers, firewalls, load balancers, routers, and switches, the alert controller 150 may receive thousands of alerts 30 per minute. These alerts 30 could range from minor issues, such as low disk space warnings, to critical failures, such as server outages or security breaches. The system's ability to handle and process such a high volume of alerts 30 efficiently is crucial for maintaining the overall health and security of the network.

The alert controller 150 may include one or more alert receivers 34. The alert receiver 34 may be any component, device, or system that receives or collects alerts 30 from the alert source 32. The alert receiver 34 may communicate with the alert source 32 via the network 112 or other communication channels. The alert receiver 34 may store the alerts 30 at the data store 148 or other storage devices. The alert receiver 34 may also filter, validate, or preprocess the alerts 30. The alert controller 150 may communicate with the data store 148 or other sources to obtain or store information related to the alerts 30, buckets 210, grouping jobs 314, notifications 170, or other data.

In some examples, each alert 30 is based on a status of a data center, data warehouse, or any other data platform. For example, the alert source 32 is a component, a device, or a system that monitors or controls the data center and may generate alerts 30 based on the status of the data center. The status of the data center may indicate the operation or availability of various components, devices, or systems within the data center, such as servers, firewalls, load balancers, routers, or switches. The status of the data center may also indicate the performance or utilization of various resources, services, or functions within the data center, such as CPU, memory, disk, network, power, cooling, or security. The alerts 30 may provide useful information for detecting and resolving issues, such as failures, errors, anomalies, or bottlenecks, that may affect the data center.

The alert controller 150 may include a bucket assignor 202. The bucket assignor 202 assigns each alert 30 to a respective bucket 210 of a plurality of buckets 210 based on separation criteria 20. The separation criteria 20 may be based on one or more attributes of the alerts 30, such as a source of the alert 30, a type of the alert 30, a severity of the alert 30, or a time the alert 30 was generated. For example, alerts 30 from the same server (source) may be grouped together, or alerts of the same type, such as “network issues” or “application errors,” may be placed in the same bucket 210. Similarly, alerts 30 with a high severity level or those generated within the same time frame can be sorted into their respective buckets 210.

The separation criteria 20 may be predefined or configurable by the user 12 or the alert controller 150. The separation criteria 20 may be used to separate the alerts into different buckets 210 based on their relevance, similarity, or priority. The buckets 210 may be logical or physical containers or partitions that store or group the alerts 30 based on the separation criteria 20. The buckets 210 may have different sizes, capacities, or characteristics depending on the separation criteria 20 or the user preferences. The number or quantity of buckets 210 may be static (e.g., based on a user preference or a predefined metric). Optionally, the number or quantity of buckets 210 is dynamic and the alert controller 150 adjusts the quantity of buckets 210 based on factors such as alert volume.

In some implementations, the alert controller 150 includes a grouping controller 310. The grouping controller 310 is configured to distribute the alerts 30 across a plurality of grouping jobs 314 based on the assigned respective bucket 210. Each grouping job 314 is associated with one or more buckets 210. Each grouping job 314 may be assigned or be associated with one or more buckets 210. While each grouping job 314 may be responsible for more than one bucket 210, generally a bucket 210 is not split across multiple grouping jobs 314.

Each grouping job 314 may be a unit or a process of work that is configured to group the alerts 30 within one or more buckets 210 based on the respective cause for each alert 30. Each grouping job 314 may be associated with one or more buckets 210, such that each bucket 210 is assigned to a grouping job 314. The distribution of the alerts 30 across the plurality of grouping jobs 314 may be based on the assigned respective bucket 210, such that each alert 30 is distributed to the grouping job 314 that is associated with the bucket 210 to which the alert 30 is assigned. The distribution of the alerts 30 across the grouping jobs 314 may also be based on other factors, such as the load balancing, the resource allocation, the performance optimization, or the user preferences of the alert controller 150.

The grouping controller 310, in some implementations, groups the alerts 30 within each bucket 210 into one or more groups 316 based on the respective cause for each alert 30. This includes, for example, identifying alerts 30 with the same or similar root cause, which may indicate a common or related issue or problem that triggered the alerts 30. The root cause (or just cause) indicates the reason, the origin, the source, etc. of the alert 30. The grouping controller 310 may determine or identify the cause for the alert 30 based on the alert source 32, the alert receiver 34, or the alert controller 150 based on various factors, such as the content, the context, the metadata, the history, or the correlation of the alert 30. The cause for each alert 30 may be expressed in natural language, such as a text description, a tag, a label, or a category, or in other formats, such as a code, a symbol, a number, or a value.

The grouping controller 310 may identify alerts 30 with the same or similar root cause by determining one or more of a text similarity, a tag similarity, or a correlation analysis for each alert 30. The text similarity may measure the degree of similarity or difference between the natural language descriptions of the causes for the alerts 30. The tag similarity may measure the degree of similarity or difference between the tags, labels, or categories of the causes for the alerts 30. The correlation analysis may measure the degree of correlation or association between the alerts based on their attributes, such as their sources, types, severities, or times. The grouping of the alerts 30 within each bucket 210 may result in one or more groups 316 of alerts 30. In these scenarios, each group 316 of alerts 30 includes alerts 30 with the same or similar root cause.

Optionally, the alert controller 150 includes a notification generator 320. The notification generator 320 may be configured to generate, for each group 316 of alerts 30, a single notification 170. The notification 170 may be a message or a report (e.g., an incident or incident report) that summarizes or represents the group 316 of alerts 30, providing the user 12 with a streamlined and less overwhelming way to manage and respond to alerts 30. For example, the single notification 170 may replace receiving thousands of alerts 30 a minute. The notification 170, in some examples, includes information such as the number, the type, the severity, the source, the time, or the root cause of the alerts 30 in the group 316. The notification 170 may also include information such as the status, the progress, the outcome, or the recommendation for mitigating the cause of the alerts 30. The notification 170 may be formatted, styled, or highlighted to attract the user's attention, to emphasize the importance or the likelihood of the notification 170, or to indicate the compatibility or the suitability of the notification 170. The notification 170 may be generated using natural language generation, text summarization, or other techniques. In some implementations, the notification generator 320 causes the notification 170 to be sent or displayed to the user 12 via the network 112, the GUI 15, or other communication channels.

In some examples, the alert controller 150, prior to generating the notification(s) 170, determines that each grouping job 314 has completed grouping the alerts 30 within each bucket 210 using the grouping controller 310 and/or the notification generator 320. The determination may be based on various criteria, such as a completion status, a completion time, a completion message, or a completion signal of each grouping job 314. The determination may ensure the consistency, the accuracy, or the completeness of the notifications 170 generated by the alert controller 150. For example, if the notification generator 320 generates the notification 170 before the grouping jobs 314 have completed grouping the alerts 30, the user 12 may receive notifications 170 for the ungrouped alerts 30, which may greatly increase the quantity of notifications 170 received by the user 12. On the other hand, if the notification generator 320 waits for an extended period of time after the grouping jobs 314 have completed grouping the alerts 30 before sending the notifications 170, the alerts 30 may become stale and/or high priority issues may go unaddressed.

In some implementations, determining that each grouping job 314 has completed includes waiting for a threshold amount of time (e.g., five minutes). The threshold amount of time may indicate a maximum or expected duration for each grouping job 314 to complete grouping the alerts 30 within each bucket 210. Alternatively or additionally, the threshold amount of time indicates an amount of time before alerts 30 may become stale or an amount of time that high priority alerts 30 can be delayed. The threshold amount of time may be predefined or configurable by the user 12 or the alert controller 150. The threshold amount of time may be based on various factors, such as the number, the type, the severity, or the complexity of the alerts 30, the buckets 210, or the grouping jobs 314, or the load, the capacity, or the performance of the alert controller 150. Waiting for the threshold amount of time may allow the alert controller 150 to synchronize the grouping jobs 314 and to handle any delays or errors that may occur during the grouping process.

In some examples, the threshold amount of time is based on a user preference. For example, the user 12 specifies or adjusts the threshold amount of time via the GUI 15 or other interfaces. The user preference may reflect the user's expectation, requirement, or tolerance for the alert grouping. The user preference may also depend on the urgency, the priority, or the impact of the alerts, the use case, or the notifications.

In some implementations, the alert controller 150 incorporates a smart synchronization algorithm to manage dependencies between different job types. This algorithm ensures that the notification generator 320 waits for all grouping jobs 314 to run or execute before generating notifications or assigning incidents, preventing the creation of multiple notifications/incidents for the same issue. The synchronization mechanism may use a dedicated table with hash markers to track the status of each grouping job 314 on a temporal axis. This ensures that the alert management is coordinated and efficient, avoiding unnecessary delays and ensuring timely incident creation. Configurable system properties may allow users to set maximum waiting times for critical incident creation, balancing the need for prompt response with the goal of avoiding clutter.

In some implementations, the alert controller (e.g., the grouping controller 310 or the notification generator 320), for each grouping job 314, generates a respective hash marker indicating a completion status of the grouping job 314 in a synchronization table. Based on the synchronization table, the alert controller 150 may determine that all the grouping jobs 314 have completed. The hash marker may be a code, a symbol, a number, or a value that indicates whether the grouping job 314 has completed grouping the alerts within each bucket 210 or not. The synchronization table may be a data structure, a file, a record, or a database that stores the hash markers for each grouping job 314. The synchronization table may be stored in the data store 148 or other storage devices. The alert controller 150 may update the synchronization table with the respective hash marker for each grouping job 314 when the grouping job 314 completes or fails to complete. The alert controller 150 may check the synchronization table periodically to determine whether all the grouping jobs 314 have completed or not. Optionally, a notification may be pushed to the alert controller 150 when the synchronization table indicates that the grouping jobs 314 have completed. The synchronization table may provide a reliable, efficient, or scalable way for the alert controller 150 to synchronize the grouping jobs 314 and to handle any delays or errors that may occur during the grouping process. Similarly, the hash marker may indicate that the grouping job 314 has failed to complete due to various reasons, such as an error, an exception, a timeout, or a cancellation. The alert controller 150 may check the synchronization table to determine whether any grouping job 314 has failed to complete or not.

The alert controller 150 may provide dynamic backup and resilience strategies to handle job failures. If a grouping job 314 fails, the alert controller 150 may dynamically reassign the alerts 30 assigned to the failed grouping job 314 to a different grouping job 314. This reassignment may be based on various factors, such as the load, capacity, and performance of the available grouping jobs 314. This dynamic reassignment ensures that the system can continue processing alerts efficiently, even in the event of job failures, enhancing the overall resilience and availability of the system 100.

In some implementations, the alert controller 150 reassigns the alerts 30 assigned to a grouping job 314 that failed to complete to a different grouping job 314 and updates the synchronization table based on the reassignment. The reassignment may involve selecting a different grouping job 314 that is associated with the same or a different bucket 210 as the grouping job 314 that failed to complete and transferring the alerts 30 assigned to the grouping job 314 that failed to complete to the selected different grouping job 314. The reassignment may be based on various factors, such as the load, the capacity, or the performance of the different grouping job 314, or the user preferences, the policies, the rules, or the thresholds of the alert controller 150. The reassignment may allow the alert controller 150 to recover from the failure of the grouping job 314 and to ensure the completion of the alert grouping. The alert controller 150 may update the synchronization table with the respective hash marker for the grouping job 314 that failed to complete and the selected different grouping job 314 based on the reassignment.

In some implementations, the alert controller 150, after each grouping job 314 groups the alerts 30 within each bucket 210, performs, for each group 316 of alerts 30, one or more actions. The actions may include creating incident reports, sending notifications, and performing basic remediation tasks. For example, the grouping controller 310, the notification generator 320, or a different module performs remediation. The remediation may include performing one or more actions or tasks to resolve or mitigate the issue or problem that caused the group 316 of alerts 30. The remediation may be performed automatically by the alert controller 150 or manually by the user 12 (or other entity). The remediation may be based on at least one of the root cause, the severity, the priority, or the impact of the group 316 of alerts 30. Additionally or alternatively, the remediation is based on the user preferences, the policies, the rules, or the thresholds of the alert controller 150. The remediation may include actions or tasks such as restarting, repairing, replacing, or updating a component, device, or application that generated the group 316 of alerts 30, or adjusting, modifying, or optimizing a parameter, a configuration, or a setting of the component, device, or application.

In some examples, the alert controller 150 determines a current alert volume. The current alert volume indicates the number, the frequency, the rate, or the intensity of the alerts 30 received or processed by the alert controller 150. Based on the determined current alert volume, the alert controller 150 may scale a number of the grouping jobs 314. For example, the alert controller 150 determines the current alert volume and scales the number of grouping jobs 314 using the grouping controller 310. This scaling allows the system to dynamically react to sudden increases in alerts without losing performance, ensuring that the alert processing remains efficient and effective. Additionally, the scaling allows the system to efficiently use resources by scaling down when the quantity of alerts is low.

The current alert volume may be compared to a baseline, a threshold, a range, or a trend of the alert volume. Based on the determined current alert volume, the alert controller 150 may scale the number of the grouping jobs 314 up or down to adjust the alert processing capacity or performance of the alert controller 150. Optionally, the alert controller 150 scales the number of the grouping jobs 314 when the current alert volume satisfies a threshold. For example, the alert controller 150 increases the number of the grouping jobs 314 when the current alert volume is high or increasing (e.g., above a threshold) or decrease the number of the grouping jobs 314 when the current alert volume is low or decreasing (e.g., below a threshold). The scaling of the number of the grouping jobs 314 may be performed automatically by the alert controller 150 or manually by the user 12.

In some implementations, each grouping job 314 is executed in parallel with each other grouping job 314. For example, the alert controller 150 executes each grouping job 314 in parallel using the grouping controller 310. The parallel execution of the grouping jobs 314 may enhance the efficiency, the scalability, or the performance of the system 100. The parallel execution of the grouping jobs 314 may be enabled by the distribution of the alerts 30 across the plurality of grouping jobs 314 based on the assigned respective bucket 210, which may reduce the dependency or the interference between the grouping jobs 314.

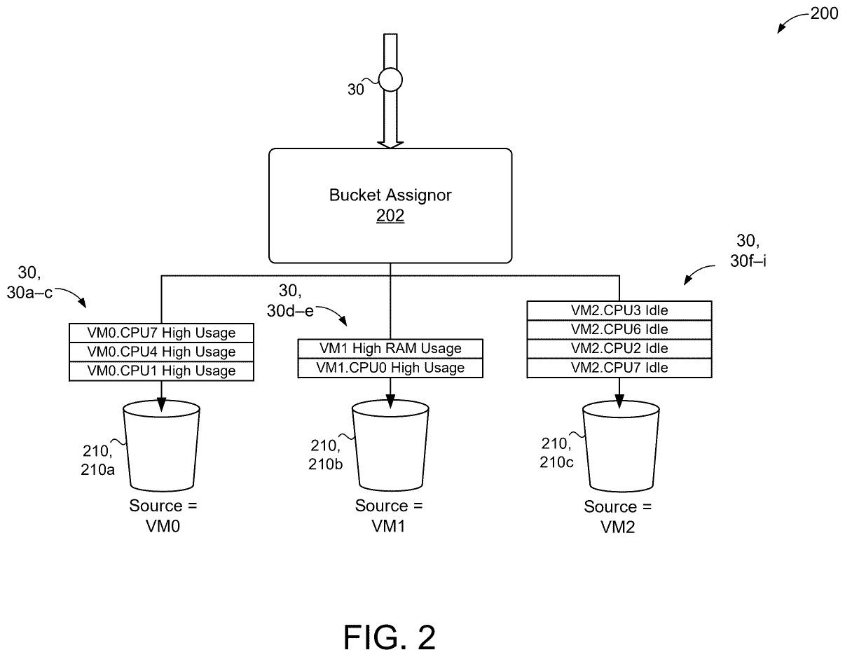

Referring now to FIG. 2, a schematic view 200 illustrates a bucket assignor 202 assigning multiple alerts 30 to different buckets 210. Here, the bucket assignor 202 assigns the alerts 30 to buckets 210 based on a source of the alert 30. For example, alerts 30 associated with a first source (i.e., a first virtual machine or VM0) are assigned to a first bucket 210, 210 a. Here, alerts 30, 30a-c indicate that various CPUs associated with VM0 are experiencing high usage. Similarly, alerts 30 associated with a second source (i.e., VM1) are assigned to a second bucket 210, 210b. In this example, the alerts 30, 30d-e indicate high CPU and RAM usage for VM1. Additionally, alerts 30 associated with a third source (i.e., VM2) are assigned to a third bucket 210, 210c. Here, alerts 30, 30f-i are associated with various CPUs associated with VM2 are idle. The alerts, sources, and buckets of FIG. 2 are merely exemplary. The alerts 30 may be caused by any condition and sourced by any number of components of the system 100. Moreover, the system 100 may include any number of buckets (e.g., based on the type, quantity, frequency, etc., of alerts 30).

In some examples, the bucket assignor 202 selects or determines the appropriate bucket 210 for a particular alert 30 based at least in part on a hash of one or more parameters or fields or properties associated with the alert 30. The properties may be configured by the user 12. In some examples, the properties are configured as key-value pairs, such as a (“resource,” “metric name”) key-value pair. For example, a property of the alert 30 may be (CPU1, CPU1 Usage) which indicates that the resource is “CPU1” and the metric name is “CPU1 Usage.” The bucket assignor 202 may hash these one or more properties to determine which bucket 210 the alert 30 should be assigned to, as the hash will ensure that similar alerts 30 (i.e., alerts 30 with similar or the same properties) are assigned to the same bucket 210. In some implementations, the bucket assignor 202 determines the appropriate bucket 210 based on the hash of the properties (e.g., a string hash code) modulus the number of grouping jobs 314.

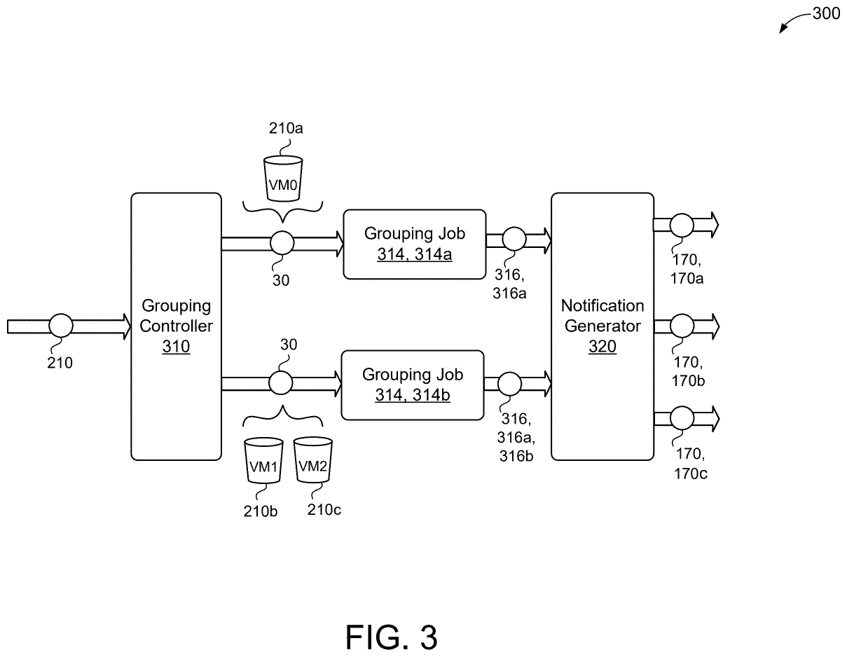

Referring now to FIG. 3, a schematic view 300 includes an exemplary grouping controller 310 and notification generator 320. In this example, the grouping controller 310 has received the buckets 210 and alerts from the example of FIG. 2. Here, the grouping controller 310 has assigned the alerts 30 of the first bucket 210a to a first grouping job 314, and the grouping controller 310 has assigned the alerts 30 of the second bucket 210b and third bucket 210c to a second grouping job 314. This configuration is merely exemplary, and the grouping controller 310 may assign any combination of buckets 210 to any number of grouping jobs 314 based on a number of factors, such as alert quantity, alert frequency, alert priority, system resources, etc.

In some examples, the alert controller 150 does not include the grouping controller 310. In these examples, each grouping job 314 may be aware directly of the alerts 30 and/or buckets 210 that the grouping job 314 is responsible for grouping. For example, when created, each grouping job 314 may be assigned specific buckets 210 and the grouping job 314 may pull alerts 30 from a general pool or queue based on the assigned specific buckets 210.

The number of grouping jobs 314 may be dynamic. For example, when the quantity or frequency (or any other appropriate metric) of the alerts 30 satisfies a threshold, the grouping controller 314 may increase or decrease the number of grouping jobs 314 to more efficiently manage the alerts 30. For example, when the frequency of alerts 30 increases for a threshold period of time, the grouping controller 310 adds additional grouping jobs 314 in order to increase the parallel grouping capabilities of the grouping jobs 314. In this example, if VM1 or VM2 were to suddenly begin generating more alerts 30, the grouping controller 310 may respond by creating an additional grouping job 314, and then reassigning alerts 30 associated with VM1 or VM2 to the new grouping job 314. This allows the alert controller 150 to continue grouping alerts 30 and generating notifications 170 within a threshold period of time of receiving the alerts 30 (which may be configurable by the user 12) without missing or otherwise failing to process some of the alerts 30.

When the grouping jobs 314 have finished grouping the alerts 30 and/or a threshold period of time has passed, the notification generator 320 generates a single notification 170 for each group 316 of alerts 30. Here, the notification generator 320 received three groups 316 of alerts 30 and subsequently generated three notifications 170, 170a-c. Notably, these three notifications 170 may represent any number (e.g., thousands) of alerts 30. Each notification 170a-c may be provided to the user 12 (e.g., via the GUI 15).

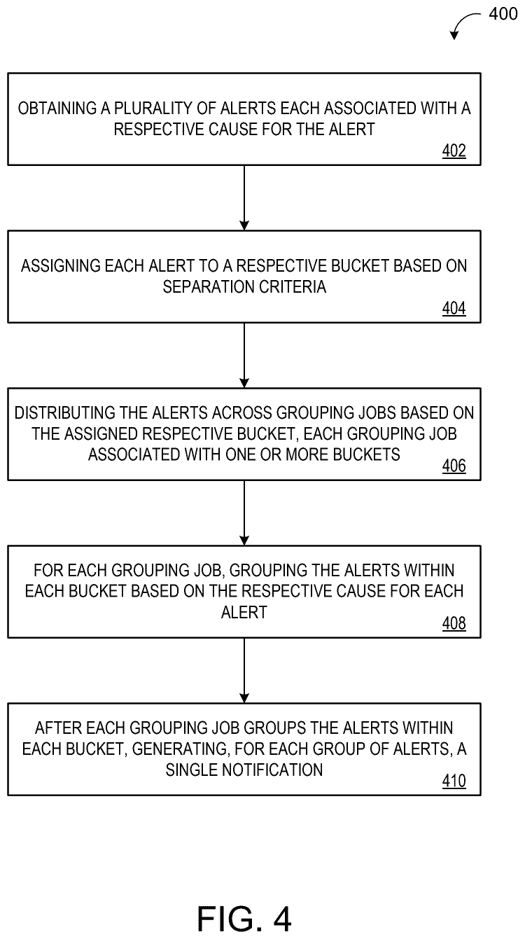

FIG. 4 is a flowchart of an exemplary arrangement of operations for a method 400 of grouping alerts in a scale-out environment. The method 400, at operation 402, includes obtaining a plurality of alerts 30. Each alert 30 of the plurality of alerts 30 is associated with a respective cause for the alert 30. This approach addresses the challenge of managing a high volume of alerts by ensuring that each alert is linked to its root cause, facilitating more efficient troubleshooting. The method 400, at operation 404, includes assigning each alert 30 to a respective bucket 210 of a plurality of buckets 210 based on separation criteria 20. By using separation criteria such as the source, type, severity, or time of the alert, the system ensures that alerts are logically grouped, which enhances the manageability and relevance of the alert groups. At operation 406, the method 400 includes distributing the alerts 30 across a plurality of grouping jobs 314 based on the assigned respective bucket 210. Each grouping job 314 is associated with one or more buckets 210 of the plurality of buckets 210. This distribution allows for parallel processing of alerts, significantly improving the system's scalability and performance by avoiding bottlenecks associated with single-job processing. For each grouping job 314, the method 400 includes grouping the alerts 30 within each bucket 210 based on the respective cause for each alert 30. This step ensures that alerts with the same root cause are grouped together, reducing the number of notifications and enabling quicker identification and resolution of issues. After each grouping job 314 groups the alerts 30 within each bucket 210, the method 400, at operation 410, includes generating, for each group 316 of alerts 30, a single notification 170. This notification generation step, which can include creating incident reports, provides a streamlined and less overwhelming way for administrators to manage and respond to alerts, thereby enhancing the overall efficiency and effectiveness of the alert management process.

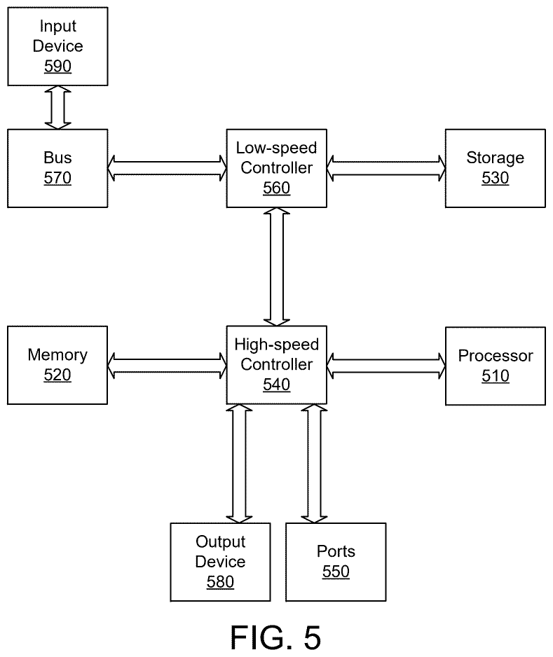

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a plurality of alerts, each alert of the plurality of alerts associated with a respective cause for the alert;
assigning each alert to a respective bucket of a plurality of buckets based on separation criteria;
distributing the alerts across a plurality of grouping jobs based on the assigned respective bucket, each grouping job associated with one or more buckets of the plurality of buckets;
for each grouping job, grouping the alerts within each bucket based on the respective cause for each alert; and
after each grouping job groups the alerts within each bucket, generating, for each group of alerts, a single notification.

2. The method of claim 1, wherein the separation criteria are based on one or more attributes of the alerts.

3. The method of claim 2, wherein the one or more attributes comprise at least one of a source of the alert, a type of the alert, a severity of the alert, or a time the alert was generated.

4. The method of claim 1, wherein grouping the alerts within each bucket based on the respective cause for each alert comprises identifying alerts with the same root cause.

5. The method of claim 4, wherein identifying alerts with the same root cause comprises determining at least one of a text similarity, a tag similarity, or a correlation analysis for each alert.

6. The method of claim 1, wherein generating the single notification comprises generating an incident report.

7. The method of claim 1, further comprising, after each grouping job groups the alerts within each bucket, performing, for each group of alerts, remediation.

8. The method of claim 1, further comprising:
determining a current alert volume; and
based on the determined current alert volume, scaling a number of the plurality of grouping jobs.

9. The method of claim 1, wherein each grouping job is executed in parallel with each other grouping job.

10. The method of claim 1, further comprising, prior to generating the single notification, determining that each grouping job has completed grouping the alerts within each bucket.

11. The method of claim 10, wherein determining that each grouping job has completed comprises waiting for a threshold amount of time.

12. The method of claim 11, wherein the threshold amount of time is based on a user preference.

13. The method of claim 1, further comprising:
for each grouping job, generating a respective hash marker indicating a completion status of the grouping job in a synchronization table; and
determining, based on the synchronization table, that all the grouping jobs have completed.

14. The method of claim 1, further comprising:
for each grouping job, generating a respective hash marker indicating a completion status of the grouping job in a synchronization table; and
determining, based on the synchronization table, a grouping job has failed to complete.

15. The method of claim 14, further comprising:
reassigning the alerts assigned to the grouping job that failed to complete to a different grouping job; and
updating the synchronization table based on the reassignment.

16. The method of claim 1, wherein each alert of the plurality of alerts is based on a status of a data center.

17. The method of claim 16, wherein each alert of the plurality of alerts is associated with at least one of a server, a firewall, a load balancer, a router, or a switch.

18. A system comprising:
data processing hardware; and
memory hardware in communication with the data processing hardware, the memory hardware storing instructions that when executed on the data processing hardware cause the data processing hardware to perform operations comprising:
obtaining a plurality of alerts, each alert of the plurality of alerts associated with a respective cause for the alert;
assigning each alert to a respective bucket of a plurality of buckets based on separation criteria;
distributing the alerts across a plurality of grouping jobs based on the assigned respective bucket, each grouping job associated with one or more buckets of the plurality of buckets;
for each grouping job, grouping the alerts within each bucket based on the respective cause for each alert; and
after each grouping job groups the alerts within each bucket, generating, for each group of alerts, a single notification.

19. The system of claim 18, wherein the operations further comprise:
determining a current alert volume; and
based on the determined current alert volume, scaling a number of the plurality of grouping jobs.

20. A computer-readable medium having instructions that, when executed by data processing hardware, causes the data processing hardware to perform operations comprising:
obtaining a plurality of alerts, each alert of the plurality of alerts associated with a respective cause for the alert;
assigning each alert to a respective bucket of a plurality of buckets based on separation criteria;
distributing the alerts across a plurality of grouping jobs based on the assigned respective bucket, each grouping job associated with one or more buckets of the plurality of buckets;
for each grouping job, grouping the alerts within each bucket based on the respective cause for each alert; and
after each grouping job groups the alerts within each bucket, generating, for each group of alerts, a single notification.
